(19) United States
(12) Patent Application Publication
(10) Pub. No.: US 2025/0377290 A1
(43) Pub. Date: Dec. 11, 2025

(54) APPARATUS AND METHOD FOR RAPID TESTING OF TIME DEPENDENT TRACER PERFORMANCE FOR USE IN FRACTURED GAS WELLS

(71) Applicant: SAUDI ARABIAN OIL COMPANY, Dhahran (SA)

(72) Inventors: Ayrat GIZZATOV, Winchester, MA (US); Nermeen SAADOUN, Somerville, MA (US); Sulaiman Ali AL-SUHAIBANI, Austin, TX (US)

(73) Assignees: SAUDI ARABIAN OIL COMPANY, Dhahran (SA); ARAMCO SERVICES COMPANY, Houston, TX (US)

(21) Appl. No.: 18/735,283

(22) Filed: Jun. 6, 2024

(51) Int. Cl. G01N 21/17; G01N 23/223; G05D 7/06

(52) U.S. Cl. CPC G01N 21/17; G01N 23/223; G05D 7/0647; G01N 2021/1746; G01N 2223/076

(57) ABSTRACT

Described is a testing assembly and method for testing performance of a tracer. The testing assembly includes a sample housing containing a tracer sample in fluid connection with a mass flow controller. The mass flow controller is connected with a source of an inert gas and controls a rate of flow of the inert gas into the sample housing. An injection device is connected with the sample housing to introduce a treatment fluid into the sample housing. A differential pressure transducer measures a change in pressure within the sample housing. A filtering device in connection with the sample housing filters a resultant fluid to capture tracer particulate matter that is released from the sample housing. The tracer particulate matter and resultant fluid are analyzed for presence of the tracer at various time points in order to evaluate degradation of the tracer under simulated gas reservoir conditions.

### BACKGROUND

In the oil and gas industry, effective monitoring of gas produced post-stimulation operations is vital due to inherent uncertainties about the actively gas-producing stage. Traditional methods, such as production logging tools, may be limiting due to substantial costs and inefficiencies in time and use.

Tracers are used for monitoring, mapping and confirming the presence of hydrocarbons in place as well as the production of hydrocarbons from various zones of interest in a reservoir. For example, tracers are used for applications such as waterflood optimization, remaining oil saturation determination, fluid pathway identification, and inter-well connectivity determination.

Before field deployment of any tracer technology, thorough testing is essential under conditions replicating the downhole environment. Traditional testing techniques involve core flooding experiments, which may be time-consuming and expensive, particularly when testing a diverse range of samples for effective tracer chemical screening.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a testing assembly for testing performance of a tracer. The testing assembly includes a source of an inert gas, a mass flow controller in fluid connection with the source of the inert gas, and a sample housing containing a tracer sample in fluid connection with the mass flow controller. The mass flow controller is configured to control a rate of flow of the inert gas into the sample housing. The testing assembly further comprises an injection device in fluid connection with the sample housing and a first differential pressure transducer. The injection device is configured to introduce a treatment fluid into the sample housing, and the first differential pressure transducer is configured to measure a change in pressure within the sample housing. Additionally, the testing assembly includes a filtering device in fluid connection with the sample housing, which filters a resultant fluid to capture tracer particulate matter released. A container disposed downstream of the filtering device collects the filtered resultant fluid.

In another aspect, the testing assembly comprises one or more check valves disposed between the mass flow controller and the sample housing.

In another aspect, the injection device is configured to regulate a humidity level in the sample housing.

In another aspect, the testing assembly comprises a temperature-controlled enclosure configured to contain the sample housing and control a temperature of an environment surrounding the sample housing.

In another aspect, the testing assembly comprises a second differential pressure transducer configured to measure pressure across the filtering device.

In another aspect, the tracer sample comprises a mixture of proppant and a tracer.

In another aspect, the proppant is sand and the tracer is a solid particulate tracer.

In another aspect, the tracer is a biopolymer with rhodamine.

In another aspect, the testing assembly comprises a pump connected with the injection device and configured to regulate an infusion rate of the treatment fluid introduced into the sample housing.

In addition, embodiments disclosed herein relate to a method of testing performance of a tracer using a testing apparatus. The method includes providing the testing assembly described above; introducing a tracer sample into the sample housing; introducing the inert gas into the sample housing; introducing, with the injection device, a treatment fluid into the sample housing; controlling one or more experimental conditions of the sample housing; collecting, with the container, a resultant fluid discharged from the sample housing at various time points; performing an analysis of the resultant fluid from the sample housing; and detecting an amount of tracer within the resultant fluid at the various time points.

In another aspect, the resultant fluid discharged from the sample housing at the various time points is filtered with a filtering device. The filtering device captures tracer particulate matter in the resultant fluid, and an analysis of the tracer particulate matter is performed for presence of the tracer at the various time points.

In another aspect, the first differential pressure transducer measures a change in pressure within the sample housing.

In another aspect, a second differential pressure transducer measures a pressure across the filtering device.

In another aspect, the method comprises controlling a humidity level in the sample housing.

In another aspect, the method comprises controlling a pH level in the sample housing.

In another aspect, the method comprises controlling a temperature of the sample housing.

In another aspect, the analysis performed is at least one of fluorescence imaging, spectrophotometry, energy-dispersive X-ray spectroscopy, X-ray fluorescence, and chromatography.

In another aspect, the method comprises controlling a rate of flow of the inert gas introduced into the sample housing.

In another aspect, the method comprises controlling an infusion rate of the treatment fluid introduced into the sample housing.

In another aspect, the method comprises evaluating degradation of the tracer sample based on the amount of tracer.

Other aspects and advantages of the claimed subject matter will be apparent from the following description and the appended claims.

### BRIEF DESCRIPTION OF DRAWINGS

FIG. 1 is an illustration of a testing assembly according to one or more embodiments of the present disclosure.

FIG. 2A is a top, perspective-view illustration of a sample housing according to one or more embodiments of the present disclosure.

FIG. 2B is a top-view illustration of a sample housing according to one or more embodiments of the present disclosure.

FIG. 2C is a bottom, perspective-view illustration of a sample housing according to one or more embodiments of the present disclosure.

FIG. 2D is a front, perspective-view illustration of a top portion of a sample housing according to one or more embodiments of the present disclosure.

FIG. 3 is an exploded, perspective-view illustration of a sample housing according to one or more embodiments of the present disclosure.

FIG. 4 illustrates a computing system in accordance with one or more embodiments of the present disclosure.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

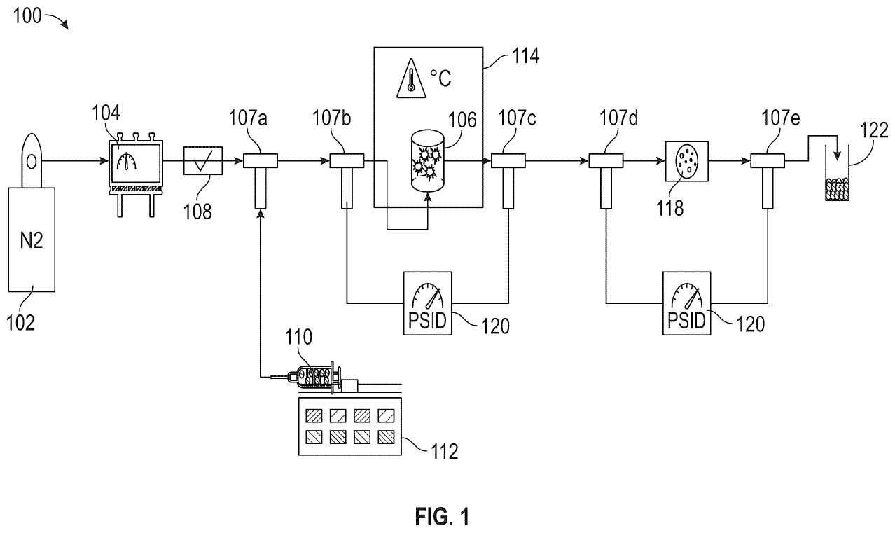

In the following description of FIGS. 1-4, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

It is to be understood that the singular forms “a,” “an,” and “the” include plural referents unless the context clearly dictates otherwise. Thus, for example, reference to “a passive soil gas sample system” includes reference to one or more of such systems.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Although multiple dependent claims are not introduced, it would be apparent to one of ordinary skill that the subject matter of the dependent claims of one or more embodiments may be combined with other dependent claims.

Embodiments of the present disclosure relate to the field of tracer technology. Embodiments of the present disclosure relate to systems and methods of evaluating tracers used in the oil and gas industry. Embodiments of the present disclosure relate to systems and methods for evaluating the performance of tracers using a testing apparatus that simulates tracers placed into a fracture alongside proppant. In one aspect, embodiments disclosed herein relate to a method and apparatus for screening of gas tracers developed for monitoring post-fracking and stimulation gas production stages.

### Testing Assembly

FIG. 1 illustrates a testing assembly 100 for evaluating time-based gas tracer performance according to one or more embodiments of the present disclosure. The testing assembly 100 is designed for simple adjustments of experimental conditions, such as humidity control, pH of the treatment fluid, gas flow rate, and sample temperature. The testing assembly 100 enables swift, cost-effective tracer screening, allowing testing of a wide variety of gas production monitoring tracers under diverse conditions.

The testing assembly 100 is configured to replicate conditions present within propped open fractures. For instance, to simulate gas flow in a producing well, the testing assembly 100 comprises a source of inert gas 102, such as nitrogen gas within a nitrogen tank. Nitrogen gas is inert in nature and relatively affordable. As can be appreciated by one skilled in the art, other gases or mixtures of gases may also be utilized, such as those present in gas reservoirs (e.g., carbon dioxide, methane, hydrogen).

A flow line runs from the source of gas 102 to a mass flow controller 104 such that the mass flow controller 104 is in fluid connection with the source of gas 102. The mass flow controller 104 may include an inlet port for receiving gas 102, a mass flow sensor, a control valve, and an outlet port though which the gas 102 exits the mass flow controller 104. The mass flow controller 104 is configured to measure and control the rate of flow of the gas 102 that is introduced into a sample housing 106 in fluid connection with the mass flow controller 104. For instance, the mass flow controller 104 may control the rate of flow of nitrogen gas into the sample housing 106 up to a predetermined setpoint, or within a desired range. For instance, the gas flow rate may be set to between 0.01 standard cubic centimeters per minute (SCCM) and 100 SCCM.

The various components of the testing assembly 100 may be connected via any number or type of flow line, pipe, hose, or tubing necessary to transport one or more fluids between the various components of the testing assembly 100. A plurality of couplers 107a-107e may be arranged at multiple locations of the testing assembly 100 to connect flow lines, or fluid supply conduits, to one another. The couplers 107a-107e may be tubing connectors or some other type of connector. The types of couplers 107a-107e may vary or be the same type of coupler.

One or more check valves 108 may be disposed between the mass flow controller 104 and the sample housing 106 to prevent reverse flow of gas and potential damage to the mass flow controller 104. The sample housing 106 may include one or more inlets for receiving treatment fluids, including gases and liquids. For instance, nitrogen may flow into the sample housing 106 through an inlet in the sample housing 102. One or more treatment fluids may be provided to the sample housing 106 via an injection device 110, such as a syringe or a syringe pump. The injection device 110 may be in fluid connection with coupler 107a.

Treatment fluids may include air and gas products, including, but not limited to, air, “enriched” air, nitrogen, carbon dioxide, carbon monoxide, hydrogen sulfide, noble gases, and combinations thereof. Treatment fluids may include crude oil, natural gas, liquid condensate, other naturally-occurring hydrocarbons, and synthetic and natural fractions thereof, including, but not limited to, methane, ethane, propane, butanes, light petroleum gas (LPG), natural gas lights, naphthas, mineral spirits, mineral oils, kerosenes, “Safra oil” (that is, dearomatized mineral oil and dearomatized kerosene), BTEX (benzene/toluene/ethyl benzene/xylenes), BTX, diesels, atmospheric and vacuum gas oils, vacuum residuals, maltenes, and asphaltenes, and combinations thereof. Treatment fluids may include salts, such as salts of ammonium, sodium, calcium, cesium, zinc, aluminum, magnesium, potassium, strontium, silicates, lithium, iron, and combinations thereof. Treatment fluids may include salts that disassociate to form ions of chlorides, bromides, carbonates, hydroxides, iodides, chlorates, bromates, formats, nitrates, sulfates, phosphates, oxides, fluorides, and combinations thereof. Treatment fluids may include natural and synthetic polymers.

Treatment fluids may include tracers, or other additives, for permitting or facilitating the visual or sensor detection of the interaction of the treatment fluid with the sample. In one or more embodiments, a dye or tracer may be light or photo-sensitive such that it reacts upon exposure to light. For example, the dye or tracer may demonstrate fluorescence or phosphorescence upon exposure to electromagnetic (EM) energy, such as through visual or UV spectrum light.

In one or more embodiments, the pH of the sample conditions is controlled through the use of an acidic fluid. An acidic fluid may include an organic acid. Useful organic acids may include, but are not limited to, alkanesulfonic acids, arylsulfonic acids, formic acid, acetic acid, methanesulfonic acid, p-toluenesulfonic acid, alkyl carboxylic acids, aryl carboxylic acids, lactic acid, glycolic acid, malonic acid, fumaric acid, citric acid, tartaric acid, chloroacetic acid, dichloroacetic acid, trichloroacetic acid, fluoroacetic acid, difluoroacetic acid, trifluoroacetic acid, glutamic acid diacetic acid, methylglycindiacetic acid, 4,5-imidazoledicarboxylic acid, and combinations thereof.

An acidic fluid may include an inorganic acid, also known as a mineral acid. Strong acids may include, but are not limited to, hydrochloric acid, (HCl), chloric acid (HClO₃), hydrobromic acid (HBr), sulfuric acid (H₂SO₄), nitric acid (HNO₃), perchloric acid (HClO₄), hydroiodic acid (HI), phosphoric acid (H₃PO₄), and combinations thereof. Such acids may be introduced as liquid concentrates or provided as their own solution. In some instances, as previously described, the treatment fluid may comprise a dye or tracer that is configured to react to electromagnetic radiation (EM), such as fluorescent or phosphorescent materials, Such light-reactive dyes or tracers may assist in detecting aspects of a sample in real-time. Another example of a useful dye or tracer-type additive may include magnetically responsive material.

In one or more embodiments, the injected treatment fluid is water. The water may include one or more additives to obtain desired treatment conditions. Water introduced into the sample housing 106 may serve to create a humid environment for the sample, further simulating conditions in a gas reservoir. The injection device 110 may be configured to regulate a humidity level of the sample housing 106. In one or more embodiments, the relative humidity of the sample housing 106 may reach 100% relative humidity. Additionally, a plurality of injection devices 110 may be implemented. For instance, different treatment fluids corresponding to fluids found in a gas reservoir, such as crude oil and condensate, may be injected into the sample housing 106 during testing. In one or more embodiments, one or more injection devices 110 are connected to a pump 112, such as a syringe pump or an infusion pump, configured for controlling the injection of treatment from the one or more injection devices 110 into the sample housing 106. The infusion rate from the one or more injection devices 110 into the sample housing 106 may range from 0.01 milliliters per hour (mL/hr) to 1 mL/hr.

To further simulate gas reservoir conditions, the sample housing 106 may be placed in a temperature-controlled enclosure 114, such as an oven, to control a temperature of an environment surrounding the sample housing 106. Thus, a sample disposed in the sample housing 106 may be tested at temperatures typical of a gas reservoir, which may range from 40° C. to 160° C.

In one or more embodiments, the testing assembly 100 includes a first differential pressure transducer 116. The first differential pressure transducer 116 may be in fluid connection with coupler 107b and coupler 107c arranged on either side of the sample housing 106. The first differential pressure transducer 116 may be used to measure changes in pressure within the sample housing 106 and output an electrical signal. Changes in pressure may be detected by measuring an initial pressure followed by measurement of a pressure obtained after a period of time. A difference in the measured pressures, or differential pressure, may be used as an indicator of changes in permeability as a result of tracer degradation in the sample.

Furthermore, the testing assembly 100 may include a filtering device 118 in connection with the sample housing 106 via couplers 107c and 107d. The filtering device 118 is configured to filter a resultant fluid discharged from the sample housing 106 via one or more outlets within the sample housing 106. The resultant fluid is the fluid that results from a given testing procedure. A filter, such as a fiber filter, of the filtering device 118 may capture any tracer particulate matter released from the sample housing 106. The filtering device 118 may lead to an exhaust outlet, such as an exhaust pipe. Filters may be replaced with new filters following a duration of hours, days, or weeks, depending on the experimental setup. Used filters may then be removed and analyzed for the presence of tracers for time-based analysis. Non-limiting examples of analysis techniques include fluorescence imaging, spectrophotometry, energy-dispersive X-ray spectroscopy, and X-ray fluorescence.

Following degradation over time, the tracers will decrease in size such that the tracers leave the sample housing, which simulates a fracture, and be collected on a filter. In one or more embodiments, the filters are collected daily from the sample housing 106. Based on the amount of tracer that has accumulated on the filters, tracer performance may be determined. An end-user may analyze the collected filters using, for example, fluorescence microscopy or X-ray fluorescence, to detect the presence of tracers on the filters as well as collect information regarding the degradation time frames of each tracer as an estimate of production over time.

In one or more embodiments, the testing assembly 100 comprises a second differential pressure transducer 120 configured for measuring pressure across the filtering device 118 in order to prevent potential clogging of the filtering device 118. Similar to the first differential pressure transducer 116, the second differential pressure transducer 120 is fluidly connected with the filtering device 118 via coupler 107d positioned upstream of the filtering device 118 and coupler 107e positioned downstream of the filtering device 118 to evaluate changes in pressure caused by a clogged filter. Finally, a collection container 122, such as a beaker, may be positioned downstream of the filtering device 118 and coupler 107e to collect the resultant fluid filtered through the filtering device 118. The collected resultant fluid may then be analyzed for the presence of tracers. Non-limiting examples of techniques for analyzing the resultant fluid include fluorescence imaging, spectrophotometry, energy-dispersive X-ray spectroscopy, and X-ray fluorescence.

In one or more embodiments, the sample housing 106 comprises a confined area to house a mixture of one or more tracers and proppant, such as sand. The confined area may be disposed between two surfaces of the sample housing 106. As described previously, the two surfaces may be quartz surfaces which house the mixture of sand and tracers. The mixture of tracers and proppant within the confined area may be used to simulate placement of proppant with tracers into a propped fracture in a formation. The proppant may be sand (e.g., silica sand), treated sand (e.g., resin coated sand), or ceramic materials (e.g., sintered or fused synthetic ceramic materials), for example.

In one or more embodiments, the sample is a mixture of a solid particulate tracer, such as polymeric solid particulates, and sand to mimic conditions of a propped open fracture in a gas field. In one or more embodiments, the amount of proppant may be between 30 mg and 10 grams, and the concentration of gas tracer may be between 0.01 wt % to 1 wt %. Tracers that may be evaluated using the testing apparatus described herein include, but are not limited to, radioactive, chemical, and dye tracers. Radioactive tracers, such as tritium, are detectable at very low concentrations (e.g., parts-per-trillion). Chemical tracers may be detected using chromatography. Non-limiting examples of chemical tracers that may be screened include halogens (e.g., chlorides, bromides, iodides), thiocyanates, nitrates (e.g., ammonium nitrate), sodium chloride, methyl tertiary butyl ether (MTBE), and alcohols (e.g., methanol, ethanol, isopropanol, n-propanol, n-butanol, pentanol).

Dye tracers commonly used in the oil and gas industry include fluorescein and B rhodamine. Dye tracers may be detected at very low concentrations using spectrofluorimetry. The tracers may also include alkyl esters of fatty acids and alcohols. For example, ethyl acetate is the mostly commonly used ester. Ethyl acetate hydrolyzes and forms ethylic alcohol and acetic acid. Alcohols, ethyl acetate, and MTBE can be detected by gas-chromatography (GC-MS).

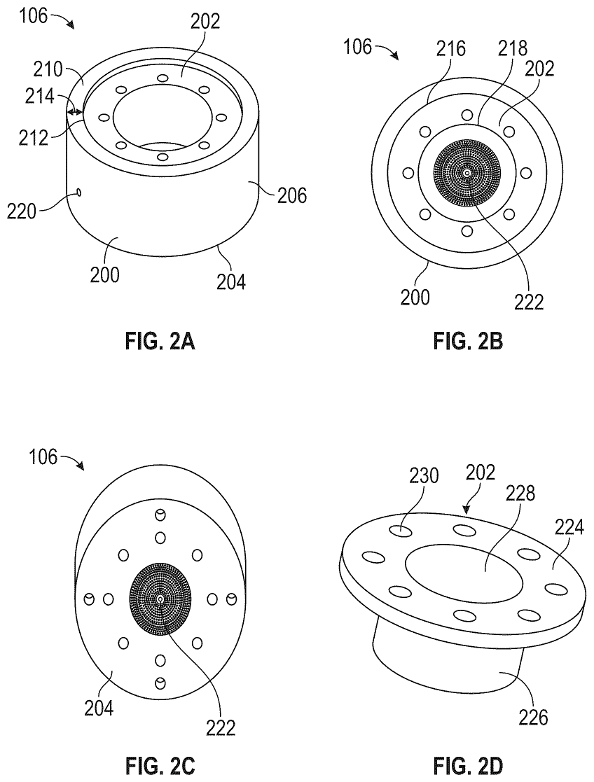

FIGS. 2A-2D show various views of the embodiment sample housing 106. One of skill in the art will note that the sample housing 106 includes versions that may be scaled upwards or downwards in size and capacity to accommodate different amounts of treatment fluid, sample sizes, and testing conditions. FIGS. 2A and 2B illustrate an assembled sample housing 106. FIG. 2A depicts a top, perspective view of the sample housing 106. In one or more embodiments, the sample housing 106 comprises a base portion 200 and a top portion 202. The base portion 200 and the top portion 202 couple to form the sample housing 106. In one or more embodiments, at least a portion of the top portion 202 fits within the base portion 200.

Embodiments of the sample housing 106 and its components may be configured to be corrosion-resistant to resist damage from introduced treatment fluids, including reactive fluids, such as acidic fluids. The top portion 202 and the base portion 200 may be comprised of materials that are resistant to reactive treatment fluids. Non-limiting examples of materials may include metals, such as Inconel® 718, Hastelloy®, Monel®, steel, and stainless steel. In some instances, certain parts of the top portion 202 and the base portion 200, such as those surfaces exposed to the treatment fluids, may be clad with such materials resistant to the treatment fluids, whereas other parts of the embodiment testing apparatus may be made of more simple or base materials. For example, at least a part of both the top portion 202 and at the base portion 200, such as an area between the top portion 202 and base portion 200 in which the sample resides, may be comprised of quartz to simulate impermeable rock or other downhole features.

The base portion 200 comprises a bottom surface 204 and at least one side wall 206 extending up from the bottom surface 204. In one or more embodiments, the base portion 200 has a circular bottom surface 204 and one continuous side wall 206 extending upward from the bottom surface 204, as illustrated in FIGS. 2A and 2C. However, as may be appreciated by one skilled in the art, the base portion 200 may alternatively have a rectangular bottom surface 204 and four side walls 206 extending from the bottom surface 204. The one or more side walls 206 form a base recess (not shown) within the base portion 200. The base recess extends from the bottom surface 204 to an upper edge of the one or more side walls 206. The base recess is formed to receive the top portion 202 such that the top portion 202 fits within the base recess of the base portion 200. In the embodiment shown, the base portion 200 has an outer diameter 210 and an inner diameter 212 created by a thickness 214 of the side wall 206.

FIG. 2B depicts a top-view of the assembled sample housing 106. As shown, the top portion 202 also comprises an outer diameter 216 and an inner diameter 218. In order for the top portion 202 to fit within the base portion 200, the outer diameter 216 of the top portion 202 is less than the inner diameter 212 of the base portion 200. The top portion 202 fits within the base recess such that a top edge of the top portion 202 and a top edge of the one or more side walls 206 sit substantially flush with each other when the sample housing 106 is assembled; however, it can be envisioned that other variations are feasible. When the top portion 202 is positioned within the base portion 200, one or more fluid-tight seals are capable of being formed. The fluid-tight seals may form when the sample housing 106 is assembled due to pressure being applied to the sample housing 106. During operation of the embodiment testing apparatus, the fluid tension of the treatment fluid, even under potentially reservoir-like temperatures and pressures, is insufficient to overcome the fine gap between the surface-surface contacts, effectively creating fluid-tight seals.

As explained above, the sample housing 106, and more specifically the base portion 200, may include one or more outlets 220 for expelling resultant fluids from the sample housing 106 following testing. In one or more embodiments, the one or more outlets 220 are disposed along an exterior of the one or more side walls 206. Resultant fluid, or slurry, from tests may be discharged from the base portion using the one or more outlets 220.

FIG. 2B illustrates a top view of the sample housing 106 with the top portion 202 positioned within the base portion 200. One or more inlets 222 may be positioned within the bottom surface 204 of the base portion 200. Samples are directly fluidly accessible through the one or more inlets 222. In the embodiment shown, the inlet 222 is disposed at an approximate center of the bottom surface 204. The inlet 222 is also depicted in FIG. 2C, which illustrates a bottom view of the sample housing 106. One or more inlets 222 may also be located along the one or more side walls 206 similar to the one or more outlets 220. Treatment fluid is introduced into the sample housing 106 such that the treatment fluid and the sample interact. Treatment fluid may be introduced into the sample through the one or more inlets 222. In one or more embodiments, a fluid conduit provides treatment fluid to the one or more inlets 222 and is coupled to the base portion 200 using the coupler 107b. The coupler 107b may be a tubing connector or some other means of coupling the fluid supply conduit to the sample housing 106.

As previously described, the treatment fluid may include one or more various fluids, including gases, liquids, and combinations thereof. The treatment fluid may be introduced at pressures and temperatures ranging from room conditions to simulated formation conditions, including high pressure/high temperature (HPHT) wellbore conditions. In some cases, HPHT may be understood to be wellbore conditions of at least 149° C. and at least 10,000 psi (pounds per square inch), although specifics on the exact definition may vary. Examples of treatment fluids may include natural and synthetic waters, such as distilled, fresh, desalinated, mineral, organic-loaded, gray, brown, black, brackish, sea, brines, formation, production, and post-industrial processing waters.

FIG. 2D shows a top, perspective-view of the top portion 202. In the embodiment shown, the top portion 202 includes an upper section 224 and a lower section 226. A top recess 228 extends from the upper section 224 to the lower section 226. At least a portion of the lower section 226 fits within the base recess of the base portion when the sample housing 106 is assembled. The top portion 202 may include fastener holes 230 therein. The fastener holes 230 are formed to permit fasteners, such as screws, to pass through the top portion 202 to fasteners holes in the base portion 200 for the purpose of securing the top portion 200 to the base portion 200. With the securing of the fasteners, a surface-to-surface contact is made that forms surface contacts within embodiments of the sample housing 106.

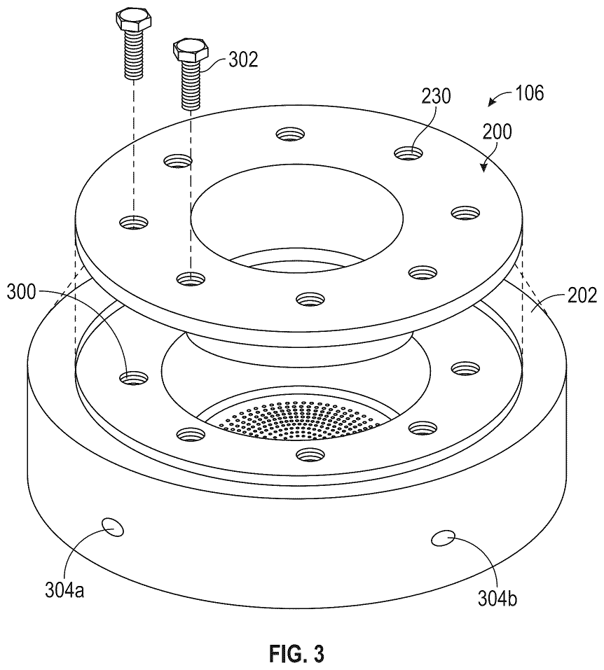

FIG. 3 illustrates an exploded perspective view of an embodiment of the sample housing 106. The exploded view of the sample housing 106 shows the top portion 202 and the base portion 200 relative to one another and how the components couple to form the sample housing 106. As shown in this view, the base portion 200 may include fastener holes 300 configured to receive fasteners 302 (e.g., screws) that are first inserted through the fastener holes 230 of the top portion 202. The base portion 200 may further include fluid distribution holes 304a and 304b, which may be inlets or outlets for fluids into or out of the sample housing 106. While the embodiment shown includes two fluid distribution holes, any number of fluid distribution holes may be disposed in the sample housing 106.

### Testing Method

The following is a non-limiting example of a method for testing tracer performance using the testing assembly described herein. The sample housing was first loaded with a sample mixture of 330 mg of Ottawa Sand and 3 mg of a tracer. To load the sample into the sample housing, the top portion was removed from the base portion, and the sample mixture was placed inside the base portion. The top portion was then positioned in the base portion and secured via fasteners. Inlet flow lines and outlet flow lines were secured to the sample housing, and the sample housing was placed inside an oven. Nitrogen gas flow was turned on at the nitrogen tank, and the gas flow rate was set to 0.6 SCCM. The oven was turned on and set to a temperature of 96.5° C. A syringe was filled with 15 mL of water, and the pump was set to an infusion rate of 0.1 mL/hr. After a predetermined amount of time, such as 24 hours, the filter was removed from the filtering device for later analysis. Additional filters were installed in the filtering device to continue gas tracer collection. Used filters were removed and analyzed for the presence of tracers, such as by gas-chromatography analysis and/or fluorescent imaging. Similar experiments may be performed with modifications to the temperature, humidity, and/or flow rate to determined how various conditions affect tracer performance (i.e., presence, concentration).

To verify the accuracy of analysis of the tracer results, multiple control samples were imaged via fluorescent imaging for reference. The following settings were used to generate images of the filters:
Exposure: 9.99 s
Gain: 7.53
Zoom: 1.34
Iris Control: 94%
IL Light: 100%
Camera Histogram (x-axis): 255
Camera Histogram (y-axis): 0.41
White Balance:
   R: 11.0
   G: 1.0
   B: 18.0
Saturation: 13
Camera Profile: new*

The various control samples included fiber filter alone, fiber filter with Ottawa sand sprinkled on top, and fiber filter with crushed and degraded polymer on top. Images were obtained of the control samples. In the images, it was observed that the sand does not fluoresce. It was also observed that the degraded polymer forms fine particles similar to a dust cloud, and the degraded polymer particles do fluoresce.

The following parameters were set for an upscaled microfluidic experiment:
Gas flow rate: 0.6 SCCM N2 Gas
Temperature: 96.5° C.
Mixture: 330 mg Ottawa Sand and 3 mg Biopolymer (150 μm-180 μm)
Water infusion rate: 0.1 ml/hour (hr)
   This experiment evaluated the production of tracers and adjustment of experimental parameters. Through experimentation it was observed that biopolymer with rhodamine material functioned as a suitable gas tracer under experimental conditions.

Embodiments of the present disclosure may provide at least one of the following advantages. The disclosed method and testing assembly enables effective screening of potential tracers to identify promising candidates for subsequent core flooding experiments. The approach significantly reduces the cost and time required for such studies from several weeks to a few days. Additionally, the method and testing assembly may be used to analyze degradation, and, thus, performance, of a particular tracer over time prior to its real-world application.

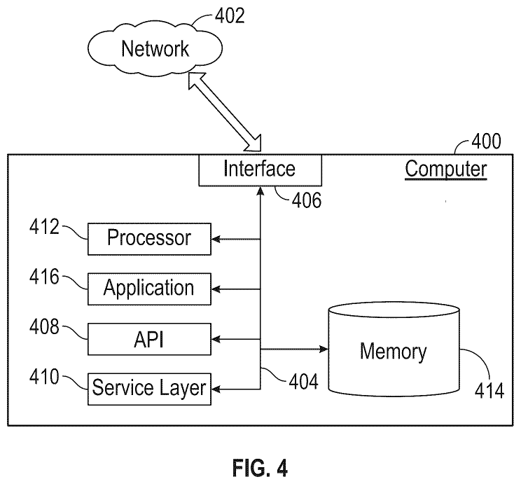

Analysis of the concentration of tracers obtained from a filter and/or the resultant fluid that passes through the filter may require computer analysis. FIG. 4 further depicts a block diagram of a computer 400 used to provide computational functionalities associated with described analysis, methods, functions, processes, flows, and procedures as described in this disclosure, according to one or more embodiments. The illustrated computer 400 is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer 400 may include an input device, such as a keypad, keyboard, touch screen, or other device that can accept user information, and an output device that conveys information associated with the operation of the computer 400, including digital data, visual, or audio information (or a combination of information), or a GUI.

The computer 400 can serve in a role as a client, network component, a server, a database or other persistency, or any other component (or a combination of roles) of a computer system for performing the subject matter described in the instant disclosure. The illustrated computer 400 is communicably coupled with a network 402. In some implementations, one or more components of the computer 400 may be configured to operate within environments, including cloud-computing-based, local, global, or other environment (or a combination of environments).

At a high level, the computer 400 is an electronic computing device operable to receive, transmit, process, store, or manage data and information associated with the described subject matter. According to some implementations, the computer 400 may also include or be communicably coupled with an application server, e-mail server, web server, caching server, streaming data server, business intelligence (BI) server, or other server (or a combination of servers).

The computer 400 can receive requests over network 402 from a client application (for example, executing on another computer 400) and responding to the received requests by processing the said requests in an appropriate software application. In addition, requests may also be sent to the computer 400 from internal users (for example, from a command console or by other appropriate access method), external or third-parties, other automated applications, as well as any other appropriate entities, individuals, systems, or computers.

Each of the components of the computer 400 can communicate using a system bus 404. In some implementations, any or all of the components of the computer 400, both hardware or software (or a combination of hardware and software), may interface with each other or an interface 406 (or a combination of both) over the system bus 404 using an application programming interface (API) 408 or a service layer 410 (or a combination of the API 408 and service layer 410). The API 408 may include specifications for routines, data structures, and object classes. The API 408 may be either computer-language independent or dependent and refer to a complete interface, a single function, or even a set of APIs. The service layer 410 provides software services to the computer 400 or other components (whether or not illustrated) that are communicably coupled to the computer 400. The functionality of the computer 400 may be accessible for all service consumers using this service layer. Software services, such as those provided by the service layer 410, provide reusable, defined business functionalities through a defined interface. For example, the interface may be software written in JAVA, C++, or other suitable language providing data in extensible markup language (XML) format or another suitable format. While illustrated as an integrated component of the computer 400, alternative implementations may illustrate the API 408 or the service layer 410 as stand-alone components in relation to other components of the computer 400 or other components (whether or not illustrated) that are communicably coupled to the computer 400. Moreover, any or all parts of the API 408 or the service layer 410 may be implemented as child or sub-modules of another software module, enterprise application, or hardware module without departing from the scope of this disclosure.

The computer 400 includes an interface 406. Although illustrated as a single interface 406 in FIG. 4, two or more interfaces 406 may be used according to particular needs, desires, or particular implementations of the computer 400. The interface 406 is used by the computer 400 for communicating with other systems in a distributed environment that are connected to the network 402. Generally, the interface 406 includes logic encoded in software or hardware (or a combination of software and hardware) and operable to communicate with the network 402. More specifically, the interface 406 may include software supporting one or more communication protocols associated with communications such that the network 402 or interface's hardware is operable to communicate physical signals within and outside of the illustrated computer 400.

The computer 400 includes at least one computer processor 412. Although illustrated as a single computer processor 412 in FIG. 4, two or more processors may be used according to particular needs, desires, or particular implementations of the computer 400. Generally, the computer processor 412 executes instructions and manipulates data to perform the operations of the computer 400 and any algorithms, methods, functions, processes, flows, and procedures as described in the instant disclosure.

The computer 400 also includes a memory 414 that holds data for the computer 400 or other components (or a combination of both) that can be connected to the network 402. For example, memory 414 can be a database storing data consistent with this disclosure. Although illustrated as a single memory 414 in FIG. 4, two or more memories may be used according to particular needs, desires, or particular implementations of the computer 400 and the described functionality. While memory 414 is illustrated as an integral component of the computer 400, in alternative implementations, memory 414 can be external to the computer 400.

The application 416 is an algorithmic software engine providing functionality according to particular needs, desires, or particular implementations of the computer 400, particularly with respect to functionality described in this disclosure. For example, the application 416 can serve as one or more components, modules, applications, etc. Further, although illustrated as a single application 416, the application 416 may be implemented as multiple applications 416 on the computer 400. In addition, although illustrated as integral to the computer 400, in alternative implementations, the application 416 can be external to the computer 400.

There may be any number of computers 400 associated with, or external to, a computer system containing computer 400, wherein each computer 400 communicates over network 402. Further, the term “client,” “user,” and other appropriate terminology may be used interchangeably as appropriate without departing from the scope of this disclosure. Moreover, this disclosure contemplates that many users may use one computer 400, or that one user may use multiple computers 400.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A testing assembly for testing performance of a tracer, comprising:
a source of an inert gas;
a mass flow controller in fluid connection with the source of the inert gas;
a sample housing in fluid connection with the mass flow controller, the sample housing having a tracer sample housed therein,
wherein the mass flow controller is configured to control a rate of flow of the inert gas into the sample housing;
an injection device in fluid connection with the sample housing, the injection device configured to introduce a treatment fluid into the sample housing;
a first differential pressure transducer configured to measure a change in pressure within the sample housing;
a filtering device in fluid connection with the sample housing, the filtering device configured to filter a resultant fluid to capture tracer particulate matter released; and
a container disposed downstream of the filtering device, the container configured to collect the filtered resultant fluid.

2. The testing assembly of claim 1, further comprising one or more check valves disposed between the mass flow controller and the sample housing.

3. The testing assembly of claim 1, wherein the injection device is configured to regulate a humidity level in the sample housing.

4. The testing assembly of claim 1, further comprising a temperature-controlled enclosure configured to contain the sample housing and control a temperature of an environment surrounding the sample housing.

5. The testing assembly of claim 1, further comprising a second differential pressure transducer configured to measure pressure across the filtering device.

6. The testing assembly of claim 1, wherein the tracer sample comprises a mixture of proppant and a tracer.

7. The testing assembly of claim 6, wherein the proppant is sand and the tracer is a solid particulate tracer.

8. The testing assembly of claim 6, wherein the tracer is a biopolymer with rhodamine.

9. The testing assembly of claim 1, further comprising a pump connected with the injection device, the pump configured to regulate an infusion rate of the treatment fluid introduced into the sample housing.

10. A method of testing performance of a tracer using a testing apparatus, comprising:
providing a testing assembly comprising:
a source of an inert gas;
a mass flow controller in fluid connection with the source of the inert gas;
a sample housing in fluid connection with the mass flow controller;
an injection device in fluid connection with the sample housing;
a first differential pressure transducer in fluid connection with the sample housing;
a filtering device in fluid connection with the sample housing; and
a container;
introducing a tracer sample into the sample housing;
introducing the inert gas into the sample housing;
introducing, with the injection device, a treatment fluid into the sample housing;
controlling one or more experimental conditions of the sample housing;
collecting, with the container, a resultant fluid discharged from the sample housing at various time points;
performing an analysis of the resultant fluid from the sample housing; and
detecting an amount of tracer within the resultant fluid at the various time points.

11. The method of claim 10, comprising:
filtering, with a filtering device, the resultant fluid discharged from the sample housing at the various time points;
capturing, with the filtering device, tracer particulate matter in the resultant fluid; and
performing an analysis of the tracer particulate matter for presence of the tracer at the various time points.

12. The method of claim 10, comprising measuring, with the first differential pressure transducer, a change in pressure within the sample housing.

13. The method of claim 12, comprising measuring, with a second differential pressure transducer, pressure across the filtering device.

14. The method of claim 10, comprising controlling a humidity level in the sample housing.

15. The method of claim 10, comprising controlling a pH level in the sample housing.

16. The method of claim 10, comprising controlling a temperature of the sample housing.

17. The method of claim 10, wherein the analysis is at least one of fluorescence imaging, spectrophotometry, energy-dispersive X-ray spectroscopy, X-ray fluorescence, and chromatography.

18. The method of claim 10, comprising controlling a rate of flow of the inert gas introduced into the sample housing.

19. The method of claim 10. comprising controlling an infusion rate of the treatment fluid introduced into the sample housing.

20. The method of claim 10. comprising evaluating degradation of the tracer sample based on the amount of tracer.
